(19) United States
(12) Patent Application Publication
(10) Pub. No.: US 2025/0230043 A1
(43) Pub. Date: Jul. 17, 2025

(54) HYDROGEN PRODUCTION FROM STEAM CRACKING TAIL GAS WITH MEMBRANE REACTOR

(71) Applicant: Saudi Arabian Oil Company, Dhahran (SA)

(72) Inventors: Aadesh Harale, Dhahran (SA); Aqil Jamal, Dhahran (SA); Rakesh Kumar, Al Khobar (SA); Mohammad Abdur Rakib, Dhahran (SA); Gerard De Nazelle, Dhahran (SA)

(21) Appl. No.: 18/410,288

(22) Filed: Jan. 11, 2024

(51) Int. Cl. C01B 3/38; C01B 3/48; C10G 9/36

(52) U.S. Cl. CPC C01B 3/382; C01B 3/48; C10G 9/36; C01B 2203/0233; C01B 2203/0244; C01B 2203/0283; C01B 2203/0405; C01B 2203/0475; C01B 2203/062; C01B 2203/1241; C10G 2400/20

(57) ABSTRACT

Methods of hydrogen (H₂) production is provided. The method includes: performing steam cracking of a feed to generate an olefin product and a tail gas including methane; reforming the methane to form a syngas including H₂ and carbon monoxide (CO); providing the syngas into a reaction vessel to a region external to a tubular membrane in the reaction vessel; providing a steam into the reaction vessel to the region; performing water-gas shift reaction (WGS) of the syngas in the reaction vessel to form a product gas including the H₂ and carbon dioxide (CO₂); diffusing the H₂ in the product gas through the tubular H₂-selective membrane into its bore; discharging the H₂ from the bore of the tubular H₂-selective membrane; discharging a remainder of the product gas from the external region; and generating heat using the H₂ as fuel, where the heat is used for the steam cracking.

### TECHNICAL FIELD

This disclosure relates to methods and systems of hydrogen (H₂) production from steam cracking tail gas using membrane reactor.

### BACKGROUND

With the rising concerns of climate change and greenhouse gas emissions, governments and companies are looking for ways to reduce their energy intensity and carbon footprint. Renewable energy such as solar, wind and geothermal is often part of the technology portfolio addressing climate change and complementing current approaches using carbon dioxide (CO₂) capture. Hydrogen (H₂) is gaining traction as a clean energy carrier as it can be produced by, for example, water electrolysis using renewable power. H₂ may also be produced from fossil fuels by, for example, coal gasification, biomass gasification, or the reforming or partial oxidation of natural gas or other hydrocarbons. The produced H₂ can be a feedstock to chemical processes, such as fuel cells, ammonia production, aromatization, hydrodesulphurization, and the hydrogenation or hydrocracking of hydrocarbons. The hydrogen can also be used as a fuel for decarbonization of industrial assets, for power generation through fuel cell or through combustion in a gas turbine or combustor.

### SUMMARY

This disclosure describes technologies relating to methods and systems of hydrogen production from steam cracking tail gas using membrane reactor.

### BRIEF DESCRIPTION OF DRAWINGS

FIG. 1 is a block diagram of hydrogen (H₂) production from a steam cracker tail gas using a membrane reactor.

FIG. 2 is a block diagram of H₂ production from a steam cracker tail gas using a membrane reactor and a separate reformer.

FIG. 3 is a membrane reactor for hydrogen H₂ production and separation.

FIGS. 4A-4B are process flow diagrams of the method of H₂ production.

FIG. 5 is a graph of H₂ flux and methane conversion.

FIG. 6 is a graph of carbon monoxide (CO) conversion at 450° C. with and without using a membrane reactor.

FIG. 7 is a graph of carbon monoxide (CO) conversion at 500° C. with and without using a membrane reactor.

### DETAILED DESCRIPTION

Implementations described herein provide methods and systems of hydrogen (H₂) production from a steam cracking tail gas. The petrochemical industry, constituting approximately 5% of global carbon dioxide (CO₂) emissions within energy-intensive industrial sectors, primarily relies on the steam cracking process for the production of petrochemicals such as ethylene, propylene, butadiene, and aromatics. The average steam cracker generates about a total of 0.9-1 ton of CO₂ per ton of high-value chemicals produced. Steam cracker fuel gases can generally be combusted to provide required endothermic energy for cracking processes, resulting in significant CO₂ emissions.

Modern steam crackers are highly optimized, with fuel gas generated from the process itself, contributing to overall energy efficiency. Efforts to further reduce CO₂ emissions include replacing methane fuel with lower-carbon alternatives such as hydrogen (H₂), capturing CO₂ from flue gas, electrifying furnace coils using renewable electricity, and oxy-fuel combustion of methane with CO₂ capture. In an H₂-production approach, a methane-rich stream, potentially supplemented with natural gas, undergoes impurity removal and reforming to produce synthesis gas (H₂ and CO). Water-gas shift (WGS) reactors then generate H₂ and CO₂, with the latter being separated from H₂ using pressure swing adsorption (PSA) or solvent systems. The produced low carbon hydrogen serves as cracker fuel, while the CO₂ is either disposed of or utilized for value-added products.

The methods and systems of H₂ production form steam cracking tail gas described in this disclosure uses a membrane reactor system with a hydrogen selective membrane to improve the process efficiency and reduce carbon footprint. A palladium or palladium-alloy membrane can be used for the membrane reactor and the tail gas from a steam cracker can be reformed to produce H₂ at a pressure suitable for steam reformer cracker furnace requirements while CO₂ is captured and separated. The membrane reactor may be used to produce H₂ via steam methane reforming (SMR). Further, the membrane reactor can be combined with autothermal (ATR) process to form a syngas (H₂ and CO) in a separate reformer, followed by water-gas shift reaction (WGS) of the syngas in the membrane reactor.

Accordingly, various implementations can reduce the overall carbon footprint of the steam cracking process by, for example, fueling the steam cracker with the produced H₂, achieving a nearly 100% CO₂ capture rate, e.g., 95% or greater, eliminating multiple process units such as CO₂ capture amine system and PSA system, and lowering a SMR process temperature. Therefore, the methods and systems herein can reduce capital and operational costs, while minimizing economic and energy penalties to olefin product manufacturing.

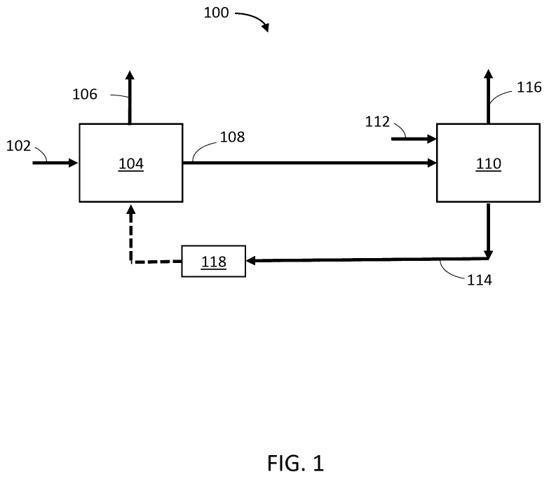

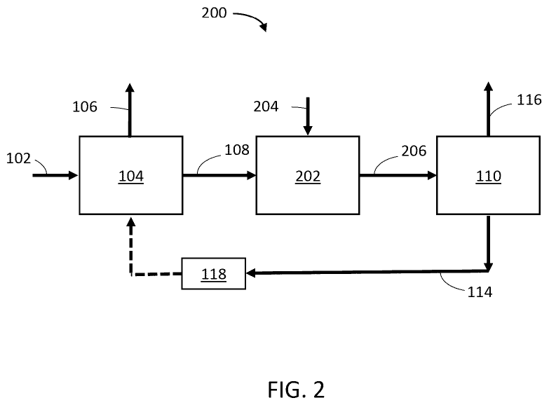

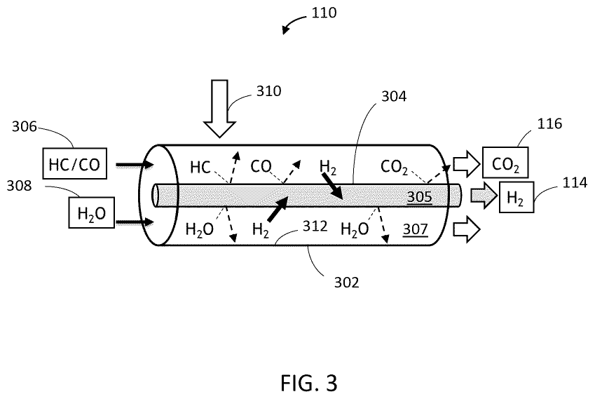

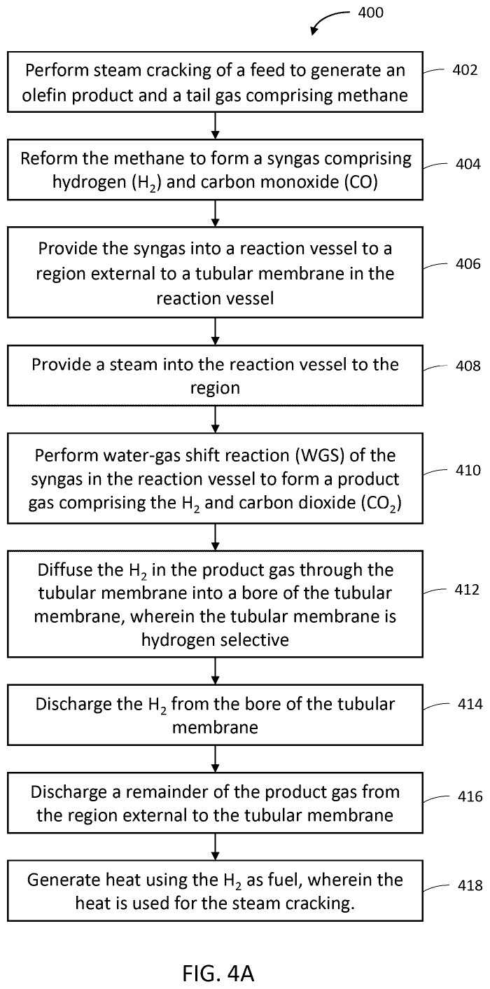

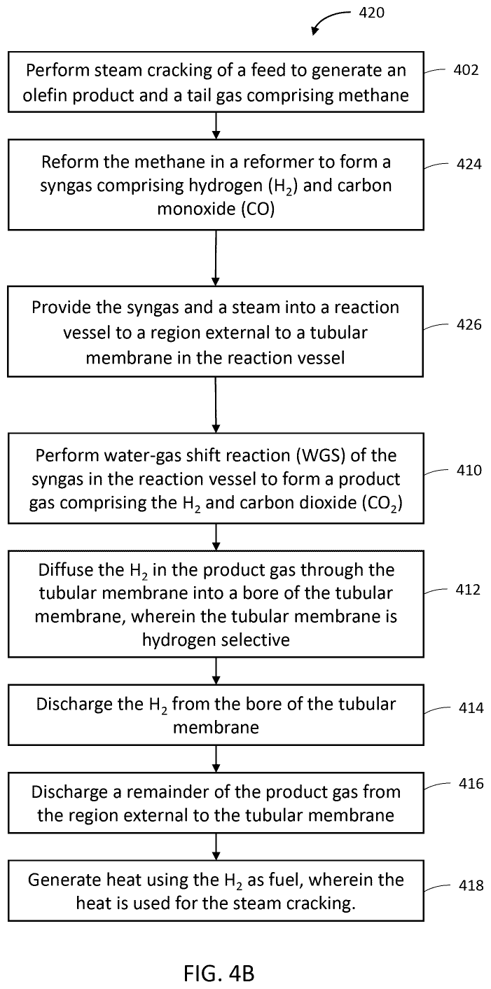

In the following, the method of H₂ production form steam cracking tail gas via SMR in the membrane reactor is described referring to FIG. 1. The method via ATR followed by WGS in the membrane reactor is then described referring to FIG. 2. A tubular design of the membrane reactor is described referring to FIG. 3. FIGS. 4A-4B are example process flow diagrams for the method of H₂ production form steam cracking tail gas. Examples experimental results are then described referring to FIGS. 5-7.

### Steam Methane Reforming (SMR) by Membrane Reactor

FIG. 1 is a block diagram of hydrogen (H₂) production 100. In various implementations, the H₂ production is a part of the oil and gas refinery facility that converts crude oil feeds into petrochemicals. The integrated process for converting crude oil to petrochemical products including olefins and aromatics, and fuel products, includes mixed feed steam cracking and conversion of naphtha to chemical rich reformate. In FIG. 1, a feed 102 is sent to a steam cracker 104 to generate an olefin product 106 and a tail gas 108. In some implementations, the feed 102 can be a naphtha or a specific kind of hydrocarbon such as ethane. The term “naphtha” as used herein refers to hydrocarbons boiling in the range of about 20-205, 20-193, 20-190, 20-180, 20-170, 32-205, 32-193, 32-190, 32-180, 32-170, 36-205, 36-193, 36-190, 36-180 or 36-170° C. The olefin product 106 can include ethylene, propylene, mixed C4 hydrocarbons, pyrolysis gasoline, and pyrolysis oil, among others. Although not specifically illustrated in FIG. 1, the steam cracker 104 can be coupled to a unit to recycle some alkane such as ethane and propane recycle.

The tail gas 108 can contain H₂ and methane (CH₄), which can be recovered as fuel. Accordingly, in some implementations, the tail gas 108 can be first treated for separation of an initial fuel gas containing H₂ before sending the tail gas 108 to a membrane reactor 110. For example, the tail gas 108 after separating the initial fuel gas can contain about 90-93% CH₄ and the remainder can be H₂ and H₂O. The tail gas 108 can also contain other minor components, e.g., below 1% combined, such as CO, C₂H₄, and C₂H₆.

The membrane reactor 110 can be used to carry out steam methane reforming (SMR) to generate a syngas (a mixture of H₂ and CO). The reactions associated with the SMR include:

CH₄+H₂O↔3H₂+CO (R1)

CO+H₂O↔3H₂+CO₂ (R2)

CH₄+2H₂O↔4H₂+CO₂ (R3)

Reaction (2) is also known as the water-shift reaction (WGS) and can take place in the membrane reactor following Reaction (1). Increasing the amount of water in the membrane reactor 110 can shift both Reactions (1), (2), and (3) to the right toward the products, which can result in increased H₂ and CO₂ production. In some implementations, accordingly, a steam can be added as an additional feed 112 to the membrane reactor 110. In some implementations, the additional feed 112 can further include an additional hydrocarbon, e.g., a natural gas import, to enhance the H₂ production in the membrane reactor 110.

The membrane reactor 110 can be charged with a SMR catalyst. The SMR catalyst can be a metal-based catalyst such as a nickel catalyst. In some implementations, a heat source provides heat to the membrane reactor 110 to regulate the temperature within the membrane reactor 110. For example, an electric heater, a furnace, or a heat loop provides heat to the membrane reactor 110.

The membrane reactor 110 includes a H₂ selective membrane such as palladium or palladium-alloy membranes, in which H₂ can selectively permeate and be recovered as a permeate fuel gas 114. A retentate gas 116 can be a CO₂-rich tail gas and CO₂ can be captured instead of releasing into the atmosphere.

The produced H₂ from the tail gas 108 can be used for power generation or as fuel for various facilities such as boilers and steam crackers. In some implementations, the produced H₂ is used to provide a part or all of the heat necessary for the steam cracker 104 to continuously perform the steam cracking of the feed. Accordingly, the permeate fuel gas 114 can be sent to a heater 118 that is connected to the steam cracker 104. In some implementations, the heater 118 is a part of or including a cracker furnace configured to generate heat by combusting H₂ in the permeate fuel gas 114. The generated heat can be provided to the steam cracker 104.

### Autothermal Reforming (ATR) Followed by Water-Gas Shift (WGS) in a Membrane Reactor

FIG. 2 is a block diagram of H₂ production 200 from a steam cracker tail gas 108 (referred to as tail gas 108) using a membrane reactor 110 and a separate reformer 202. Like numbered items are as described with respect to FIG. 1 and thus not repeated in detail. As illustrated in FIG. 2, the H₂ production 200 can use the separate reformer 202 positioned prior to the membrane reactor 110. The tail gas 108 can be sent to the separate reformer 202 to reform the hydrocarbon, e.g., methane, in the tail gas. In some implementations, the separate reformer 202 can be used to carry out autothermal reforming (ATR) of methane to generate a syngas 206. The reactions associated with the ATR include:

2CH₄+O₂+CO₂→3H₂+3CO+H₂O (R4)

4CH₄+O₂+2H₂O→10H₂+4CO (R5)

The ATR in the separate reformer 202 can be a non-catalytic process. To enable Reactions (4) and (5), in addition to the tail gas 108, a reformer feed 204 can be sent to the separate reformer 202. The reformer feed can include oxygen (O₂) and a steam. In some implementations, the reformer feed can further include an additional hydrocarbon, e.g., a natural gas import, to enhance the overall H₂ production by the process.

The syngas 206 produced in the separate reformer 202 can be sent to the membrane reactor 110 for additional H₂ production via the water-shift reaction (WGS). In some implementations, an additional steam may be added to the syngas 206 before sending it to the membrane reactor 110. The addition of steam can shift the equilibrium of the WGS to producing more H₂. In one or more implementations, the reformer feed 204 does not contain a steam and the additional steam is only added after the separate reformer 202. The membrane reactor 110 can be charged with a WGS catalyst. The WGS catalyst can be a metal-oxide catalyst such as an iron oxide catalyst or copper-based catalyst. The produced H₂ can then be recovered as a permeate fuel gas 114, while a retentate gas 116 can be a CO₂-rich tail gas and CO₂ can be captured instead of releasing into the atmosphere.

As described above referring to FIGS. 1 and 2, the membrane reactor 110 can be configured to carry out the SMR and WGS together (FIG. 1) or the WGS with a separate ATR (FIG. 2). In some implementations, the mode and configuration of the membrane reactor 110 can be selected in consideration of the final H₂ flow rate requirements for the steam cracking. Although not wishing to be limited by any theory, since the SMR-WGS mode does not require a separate reformer, it can provide higher degree of process integration and lowest H₂ production cost in comparison to the ATR-WGS mode, while the ATR-WGS mode can offer higher H₂ production capacity. Accordingly, the ATR-WGS mode can be selected for a larger olefin production capacity process, e.g., 1800 Kilo Tons per Annum (KTA).

### Design of Membrane Reactor

FIG. 3 is an example simplified view of a membrane reactor 110 for hydrogen H₂ production and separation. As described above, the membrane reactor 110 can be configured for the SMR and WGS, or WGS alone. Both implementations are described referring to FIG. 3. The membrane reactor 110 includes a reaction vessel 302 and a H₂-selective membrane 304 disposed in the reaction vessel 302. The reaction vessel 302 can be a cylindrical or tubular vessel. The reaction vessel 302 can have a horizontal orientation as illustrated in FIG. 3 or a vertical orientation. The H₂-selective membrane 304 can be tubular having a bore 305. In some implementations, the reaction vessel 302 and the H₂-selective membrane 304 are both tubular, and they are positioned concentrically. In FIG. 3, the H₂-selective membrane 304 is illustrated as a single tube contained in the reaction vessel 302 in accordance with an implementation. In some implementations, multiple tubes can be bundled and contained in the reaction vessel 302 and each tube can include the H₂-selective membrane 304.

As illustrated in FIG. 3, in operation, the carbon-containing feed 306 and a steam 308 are fed into the reaction vessel 302 to a region 307 external to the H₂-selective membrane 304. For the SMR-WGS mode, the carbon-containing feed 306 can be primarily a hydrocarbon such as methane. For the WGS mode, the carbon-containing feed 306 can be primarily a syngas.

For the SMR-WGS mode, the carbon-containing feed 306 is subjected to steam methane reforming (SMR) in the reaction vessel 302 to generate H₂ and CO. The water gas-shift reaction (WGS) can also occur converting CO into CO₂ and generate additional H₂. The reactions occur in the region 307 in the reaction vessel 302 external to the H₂-selective membrane 304. This region 307 can be seen as a reaction space and is the retentate side of the H₂-selective membrane 304. For the WGS mode, since the methane reforming has been performed in a separate reformer, only the WGS takes place in the reaction vessel 302.

The hydrogen molecules diffuse (permeate) through the wall of the H₂-selective membrane 304 wall into its bore 305. The bore 305 is the interior space of the H₂-selective membrane 304 and may be labeled as a lumen. The bore 305 is the permeate side of the H₂-selective membrane 304.

A permeate fuel gas 114 is rich in H₂ and discharges from the bore 305 of the H₂-selective membrane 304 and from the membrane reactor 110. The permeate fuel gas 114 can be, for example, at least 90 mole percent (mol %) H₂. A retentate gas 116 is rich in CO₂ and it discharges from the membrane reactor 110 from the region 307 (reaction space) around and external to the H₂-selective membrane 304. The retentate gas 116 on a dry basis can contain less than 10 mol % of the combination of H₂ and CO. The retentate gas 116 can contain unreacted steam. The retentate gas 116 can be at least 90 mol % CO₂ (dry basis) making the retentate gas 116 available in certain instances directly for further compression for geological sequestration or enhanced oil recovery (EOR), or for further purification so the CO₂ can be used as a feedstock for another process. In some implementations, the retentate gas 116 can be subjected to water removal before compression or further purification. In various implementations, the retentate gas 116 can be at about the operating pressure in the reaction vessel 302, for example, in the range of about 10 bar (1 MPa) to about 50 bar (5 MPa). Accordingly, the retentate gas 116 can provide a concentrated and pressurized CO₂ that is suitable for subsequent sequestration.

In some implementations, a sweep gas, e.g., steam or nitrogen (N₂), is provided to the bore 305 of the H₂-selective membrane 304. to flow through the bore 305 to displace H₂ from the bore 305 and the membrane reactor 110. This displacement of H₂ may maintain or increase driving force for hydrogen permeation through the membrane wall from the region 307 (reaction space) external to the H₂-selective membrane 304 into the bore 305. In one or more implementations, the sweep gas can be provided and flow in a countercurrent direction with respect to the feed of carbon-containing feed 306 and the steam 308. Thus, in those implementations, the permeate fuel gas 114 can discharge from the end opposite to the end that the retentate gas 116 discharges from the membrane reactor 110.

Since the process of reforming is generally endothermic, heat 310 may be provided to the membrane reactor 110 by using an appropriate heat source, e.g., electrical resistive heaters. The heat source can be internal or external to the membrane reactor 110. In some implementations, the reaction temperature in the membrane reactor 110 is less than about 600° C., for example, between about 550° C. and about 600° C. In one or more implementations, the reaction temperature is about 550° C. or less. The use of the membrane reactor 110 can enable the operation at this temperature range lower than a non-membrane reactor system for the SMR, e.g., about 850° C. or greater. The operating pressure in the reaction vessel 302 can be, for example, in the range of about 10 bar (1 MPa) to about 50 bar (5 MPa) or in the range of about 30 bar (3 MPa) to about 40 bar (4 MPa), or at least about 15 bar (1.5 MPa) or at least about 25 bar (2.5 MPa).

In various implementations, one or more catalysts for the SMR, WGS, or both can be used in the reaction vessel 302. For example, the SMR catalyst can be a metal-based catalyst such as a nickel catalyst, and the WGS catalyst can be a metal-oxide catalyst such as an iron oxide catalyst or copper-based catalyst. The catalyst can be disposed on an internal surface 312 of the reaction vessel 302. Further, in case of the SMR-WGS mode, the SMR catalyst can be disposed in an upstream of the reaction vessel 302 and the WGS catalyst can be disposed in a downstream of the reaction vessel 302. In some implementations, the catalyst is not in contact with the H₂-selective membrane 304.

The H₂-selective membrane 304 can be characterized or labeled as cylindrical membranes or hollow membranes. The material of the H₂-selective membrane 304 can be, for example, a palladium alloy. The membrane can be a thin film of palladium alloy supported on a tubular porous substrate composed of a metal or metal oxide.

In some implementations, there are some residual methane and CO in the retentate gas 116 due to incomplete conversion, but if the residence time is long enough, their concentrations in the retentate gas 116 can approach zero. The efficient removal of H₂ from the region 307 external to the H₂-selective membrane 304 can shift the equilibrium of Reactions (1)-(3) to the right.

The use of the membrane reactor 110 can be more efficient with respect to operational and capital costs compared to SMR or WGS using a non-membrane system. A highly selective palladium-based membrane as the tubular membrane in the membrane reactor 110 can facilitate production of high-purity H₂, e.g., about 90 mol % to about 99.9 mol % or greater, reducing downstream processing prior to utilization of the hydrogen in pure-hydrogen applications.

Further, the membrane reactor 110 can also provide a high-purity CO₂ in the retentate gas 116. In some implementations, the retentate gas 116 can be subjected to low-temperature CO₂ separation that can generate liquid CO₂ including micron-sized, high-purity CO₂ droplets. Accordingly, the method of H₂ production in this disclosure can facilitate economic capture of CO₂, e.g., 90 mol % or greater of the CO₂ generated in the H₂ production, which can be higher than solvent-based processes, e.g., 65 mol % of CO₂. In some implementations, the captured CO₂ can be at liquid state and further pressurized for transport by pumping at relatively lower energy cost without compression. The saved compression energy can increase the overall system efficiency.

In various implementations, hydrogen yield per mole of methane feed is improved in comparison to non-membrane processes as the thermodynamic conversion limitations are overcome through the membrane reactor concept. Further, slippage of methane can be reduced.

Accordingly, using the methods and systems in this disclosure, higher energy efficiency and CO₂ emission reduction in the steam cracking process can be achieved by integrating H₂ production from the steam cracking tail gas and using the produced H₂ as fuel for the steam cracking. H₂ can be obtained at a pressure useful as fuel and CO₂ can be obtained as a concentrated stream and higher pressures, resulting in lower cost and energy penalty. Further, process flexibility with membrane reactor enables the adoption of the methods to diverse olefin production facilities with different capacity requirements.

The integration using the membrane reactor system allows to provide process intensification by combining water gas shift (WGS), CO₂ capture and H₂ purification process. As a result, various costly systems such as solvent based CO₂ captures system and pressure swing adsorption (PSA) system for H₂ purification system can be eliminated.

FIGS. 4A-4B are process flow diagrams of a method of hydrogen (H₂) production from a steam cracking tail gas. In FIG. 4A, a method 400 according to an implementation starts with performing steam cracking 402 of a feed to generate an olefin product and a tail gas comprising methane, followed by reforming 404 the methane to form a syngas comprising hydrogen (H₂) and carbon monoxide (CO). This reforming of the methane at this stage can be in a separate reformer to carry out an autothermal reforming (ATR) or a membrane reactor configured to carry out subsequent reactions such as water-gas shift reaction (WGS). Subsequently, the syngas is provided 406 into a reaction vessel to a region external to a tubular membrane in the reaction vessel, where a steam is provided 408 into the reaction vessel to the region. The method 400 then proceeds to performing the WGS 410 of the syngas in the reaction vessel to form a product gas comprising H₂ and carbon dioxide (CO₂). The H₂ in the product gas is then diffused 412 through the tubular membrane into a bore of the tubular membrane, where the tubular membrane is hydrogen selective. Next, the H₂ is discharged 414 from the bore of the tubular membrane, and a remainder of the product gas is discharged 416 from the region external to the tubular membrane. Heat is then generated 418 using the H₂ as fuel, where the heat is used for the steam cracking.

In FIG. 4B, another method 420 according to an implementation starts with performing steam cracking 402 of a feed to generate an olefin product and a tail gas comprising methane, followed by reforming 424 the methane in a reformer to form a syngas comprising hydrogen (H₂) and carbon monoxide (CO). Subsequently, the syngas and a steam are provided 426 into a reaction vessel to a region external to a tubular membrane in the reaction vessel. The method 420 then proceeds to performing the WGS 410 of the syngas in the reaction vessel to form a product gas comprising the H₂ and carbon dioxide (CO₂). The H₂ in the product gas is then diffused 412 through the tubular membrane into a bore of the tubular membrane, where the tubular membrane is hydrogen selective. Next, the H₂ is discharged 414 from the bore of the tubular membrane, and a remainder of the product gas is discharged 416 from the region external to the tubular membrane. Heat is then generated 418 using the H₂ as fuel, where the heat is used for the steam cracking.

### EXAMPLES

To demonstrate the methods of H₂ production from the steam cracking tail gas, lab and pilot testing were carried out on the steam methane reforming (SMR) and membrane water-gas shift (WGS) reactors. For the SMR-WGS experiments, a commercial Ni-based SMR catalyst was used in a 15 cm palladium-gold (PdAu) membrane reactor, and methane and steam were used as a feed. The reaction was carried out at 550° C. and 30 bar (3 MPa), and the H₂ flux was measured at 3 bar (0.3 MPa) to examine the stability of membrane performance. FIG. 5 is a graph of H₂ flux and methane conversion. For an extended period of operation over 600 h, a high conversion above 70% was maintained and the H₂ flux remained mostly constant after about 300 h, demonstrating the stability of the membrane reactor system under the operating conditions and the capability to produce H₂ from the methane feed via the SMR.

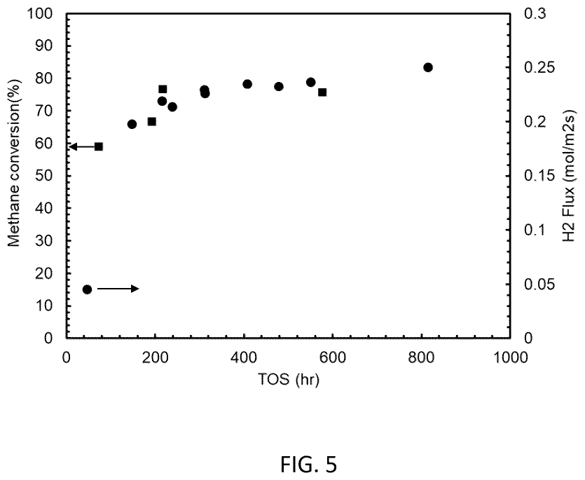

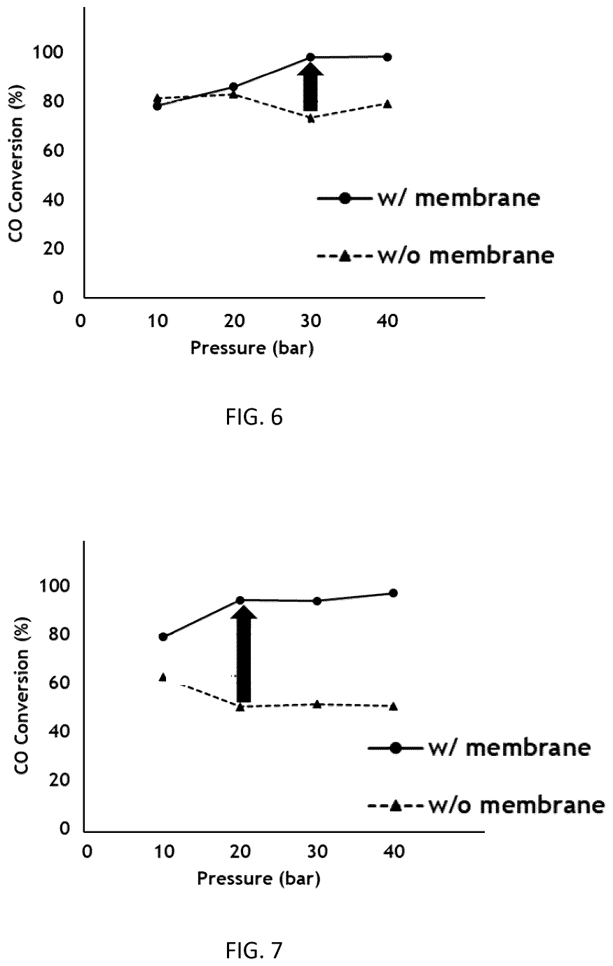

The membrane reactor system using the PdAu membrane was also examined for the WGS mode. A commercial Cu-based high temperature WGS catalyst was used in the same membrane reactor as the previous experiments, and 15 cm palladium-gold membrane and CO and steam were used as a feed. The reaction was carried out at between 450° C. and 500° C. and between 10 bar (1 MPa) and 40 bar (4 MPa). FIGS. 6 and 7 show CO conversion at 450° C. and 500° C. with and without using a membrane reactor, respectively. At both temperatures, the membrane reactor constantly exhibited a higher or similar CO conversion compared to the non-membrane reactor system, demonstrating the advantage of the membrane system. At 450° C., the benefit of the membrane reactor system in CO conversion was significant at higher pressures, e.g., 30 bar (3 MPa) or higher. At 500° C., on the other hand, the membrane reactor system exhibited the higher CO conversion at any pressure examined. At both temperatures, the CO conversion is higher at higher pressures, and near 100% conversion, e.g., 90% or greater, was obtained at 30 bar (3 MPa) or higher. Further, the high CO conversions at these temperatures, despite the moderate exothermic nature of the WGS reaction, can improve the heat integration of the SMR-WGS process and help minimizing the number of unit operations and reactors.

Material and energy balances have been calculated for both the SMR-WGS mode and the ATR-WGS mode. Aspen Plus® V12.1 software was used to model a steam cracker, an ATR, a membrane SMR reactor, and a membrane WGS reactor model, and the models were used to perform the process calculation. The two different ethylene production scales, 1000 Kilo Tons per Annum (KTA) and 1800 KTA, were calculated. The SMR-WGS mode was used for 1000 KTA and the ATR-WGS was used for 1800 KTA. For each mode, material and energy balances were calculated for a naphtha feed and an ethane feed.

Table 1 summarizes the material and energy balances for the steam cracking (1000 KTA) of naphtha with H₂ production from the steam cracking tail gas with steam methane reforming (SMR)-water-gas shift (WGS) mode. The steam cracking of naphtha at the rate of 422 t/h requires an energy input of about 711 MW. The methane from the steam cracking and a steam (additional H₂O) were assumed as a feed for the SMR-WGS in the membrane reactor. The initial H₂ obtained from the steam cracking is separated from the tail gas and not included in the feed for the membrane reactor. With the energy input of about 305 MW, the H₂ production at the membrane reactor is 24.6 t/h, which can be used to provide the heat for the steam cracking. Assuming the CO₂ (129.5 t/h) can be captured and not released into the atmosphere, the final CO₂ emission from the process can be 38.4 t/h, which is substantially reduced from the CO₂ emission from the steam cracker process without H₂ production (140.8 t/h).

TABLE 1
Material and energy balances for the steam cracking (1000 KTA)
of naphtha with H₂ production from the steam cracking tail gas
with steam methane reforming (SMR)-water-gas shift (WGS) mode.

| | Steam | Steam | Membrane | Membrane |
|---|---|---|---|---|
| | cracker | cracker | reactor | reactor |
| | input | output | input | output |
| | (t/h) | (t/h) | (t/h) | (t/h) |
| Naphtha | 422 | — | — | — |
| Initial H₂O | 210 | — | — | — |
| Ethylene | — | 127.3 | — | — |
| H₂ | — | 7.35 | — | — |
| CH₄ | — | 51.3 | 51.3 | — |
| Additional H₂O | — | — | 180 | — |
| H₂ | — | — | — | 24.6 |
| CO₂ | — | — | — | 129.5 |
| Product H₂O | — | — | — | 71.5 |

Table 2 summarizes the material and energy balances for the steam cracking (1000 KTA) of ethane with H₂ production from the steam cracking tail gas with steam methane reforming (SMR)-water-gas shift (WGS) mode. In this calculation, in addition to the methane from the steam cracking and a steam (additional H₂O), an additional methane was included in the feed for the SMR-WGS in the membrane reactor. The steam cracking of ethane at the rate of 157.8 t/h requires an energy input of about 392 MW. The initial H₂ obtained from the steam cracking is separated from the tail gas and not included in the feed for the membrane reactor. With the energy input of about 153 MW, the H₂ production at the membrane reactor is 11.7 t/h. Assuming the CO₂ (61.7 t/h) can be captured and not released into the atmosphere, the final CO₂ emission from the process can be zero. On the other hand, the steam cracker process without H₂ production at the same ethylene production rate results in the CO₂ emission of about 77.6 t/h.

TABLE 2
Material and energy balances for the steam cracking (1000 KTA)
of ethane with H₂ production from the steam cracking tail gas
with steam methane reforming (SMR)-water-gas shift (WGS) mode.

| | Steam | Steam | Membrane | Membrane |
|---|---|---|---|---|
| | cracker | cracker | reactor | reactor |
| | input | output | input | output |
| | (t/h) | (t/h) | (t/h) | (t/h) |
| Ethane | 157.8 | — | — | — |
| Recycle ethane | 82.6 | — | — | — |
| Initial H₂O | 72 | — | — | — |
| Ethylene | — | 126 | — | — |
| H₂ | — | 9.0 | — | — |
| CH₄ | — | 9.9 | 9.9 | — |
| Additional CH₄ | — | — | 12.8 | — |
| Additional H₂O | — | — | 85.4 | — |
| H₂ | — | — | — | 11.7 |
| CO₂ | — | — | — | 61.7 |
| Product H₂O | — | — | — | 34 |

Table 3 summarizes the material and energy balances for the steam cracking (1800 KTA) of naphtha with H₂ production from the steam cracking tail gas with autothermal reforming (ATR) followed by water-gas shift reaction (WGS). The steam cracking of naphtha at the rate of 750 t/h requires an energy input of about 1154 MW. The methane from the steam cracking, oxygen (O₂), a steam (additional H₂O), and an additional methane were assumed as a feed for the ATR. The initial H₂ obtained from the steam cracking is separated from the tail gas and not included in the feed for the ATR. The syngas is generated by the ATR and sent to the membrane reactor for the WGS. The syngas can have a composition as follows: 9.7 mol % CO; 9.4 mol % CO₂; 37.4 mol % H₂; and 2.5 mol % CH₄. The H₂ production at the membrane reactor is 34.6 t/h, which can be used to provide the heat for the steam cracking. Assuming the CO₂ (285.9 t/h) can be captured and not released into the atmosphere, the final CO₂ emission from the process can be zero. On the other hand, the steam cracker process without H₂ production results in the CO₂ emission of about 228.6 t/h.

TABLE 3
Material and energy balances for the steam cracking
(1800 KTA) of naphtha with H₂ production from the
steam cracking tail gas with autothermal reforming
(ATR) followed by water-gas shift (WGS) mode.

| | Steam | Steam | ATR | Membrane |
|---|---|---|---|---|
| | cracker | cracker | unit | reactor |
| | input | output | input | output |
| | (t/h) | (t/h) | (t/h) | (t/h) |
| Naphtha | 750 | — | — | — |
| Initial H₂O | 375 | — | — | — |
| Ethylene | — | 224.5 | — | — |
| H₂ | — | 13.1 | — | — |
| CH₄ | — | 91.4 | 91.4 | — |
| Additional CH₄ | — | — | 13.3 | — |
| Additional H₂O | — | — | 216 | — |
| O₂ | — | — | 142.3 | — |
| H₂ | — | — | — | 34.6 |
| CO₂ | — | — | — | 285.9 |
| Product H₂O | — | — | — | 142 |

Table 4 summarizes the material and energy balances for the steam cracking (1800 KTA) of ethane with H₂ production from the steam cracking tail gas with autothermal reforming (ATR) followed by water-gas shift reaction (WGS). The steam cracking of ethane at the rate of 300.1 t/h requires an energy input of about 726 MW. The methane from the steam cracking, oxygen (O₂), a steam (additional H₂O), and an additional methane were assumed as a feed for the ATR. The initial H₂ obtained from the steam cracking is separated from the tail gas and not included in the feed for the ATR. The syngas is generated by the ATR and sent to the membrane reactor for the WGS. The syngas can have a composition as follows: 9.1 mol % CO; 7.9 mol % CO₂; 39.94 mol % H₂; and 1.9 mol % CH₄. The H₂ production at the membrane reactor is 21.8 t/h, which can be used to provide the heat for the steam cracking. Assuming the CO₂ (158 t/h) can be captured and not released into the atmosphere, the final CO₂ emission from the process can be zero. On the other hand, the steam cracker process without H₂ production results in the CO₂ emission of about 143.8 t/h.

TABLE 4
Material and energy balances for the steam cracking
(1800 KTA) of ethane with H₂ production from the
steam cracking tail gas with autothermal reforming
(ATR) followed by water-gas shift (WGS) mode.

| | Steam | Steam | ATR | Membrane |
|---|---|---|---|---|
| | cracker | cracker | unit | reactor |
| | input | output | input | output |
| | (t/h) | (t/h) | (t/h) | (t/h) |
| Ethane | 300.1 | — | — | — |
| Initial H₂O | 135 | — | — | — |
| Ethylene | — | 231.2 | — | — |
| H₂ | — | 16.8 | — | — |
| CH₄ | — | 21.8 | 21.8 | — |
| Additional CH₄ | — | — | 35.9 | — |
| Additional H₂O | — | — | 162.1 | — |
| O₂ | — | — | 57.6 | — |
| H₂ | — | — | — | 21.8 |
| CO₂ | — | — | — | 158 |
| Product H₂O | — | — | — | 217.8 |

### Implementations

An implementation described herein provides a method of processing, where the method includes: performing steam cracking of a feed to generate an olefin product and a tail gas including methane; reforming the methane to form a syngas including hydrogen (H₂) and carbon monoxide (CO); providing the syngas into a reaction vessel to a region external to a tubular membrane in the reaction vessel; providing a steam into the reaction vessel to the region; performing water-gas shift reaction (WGS) of the syngas in the reaction vessel to form a product gas including the H₂ and carbon dioxide (CO₂); diffusing the H₂ in the product gas through the tubular membrane into a bore of the tubular membrane, where the tubular membrane is hydrogen selective; discharging the H₂ from the bore of the tubular membrane; discharging a remainder of the product gas from the region external to the tubular membrane; and generating heat using the H₂ as fuel, where the heat is used for the steam cracking.

In an aspect, combinable with any other aspect, the reforming of the methane is performed in the reaction vessel, and the method further includes: providing the tail gas into the reaction vessel to the region; and performing steam methane reforming (SMR) of the tail gas in the reaction vessel to form the syngas.

In an aspect, the method further includes providing an additional hydrocarbon into the reaction vessel to the region external to the tubular membrane.

In an aspect, the method further includes maintaining a reaction temperature in the reaction vessel during the SMR between 550° C. and 600° C.

In an aspect, combinable with any other aspect, the method includes separating the CO₂ from the remainder of the product gas.

In an aspect, combinable with any other aspect, a heat required for the steam cracking is provided entirely from the H₂.

In an aspect, combinable with any other aspect, the steam cracking forms by-product H₂, and the method further includes separating the by-product H₂ prior to providing the tail gas into the reaction vessel to the region.

An implementation described herein provides a method of processing, where the method includes: performing a steam cracking of a feed to generate an olefin product and a tail gas including methane; reforming the methane in a reformer to form a syngas including hydrogen (H₂) and carbon monoxide (CO); providing the syngas and a steam into a reaction vessel to a region external to a tubular membrane in the reaction vessel; performing a water-gas shift reaction (WGS) in the reaction vessel to form a product gas including the H₂ and carbon dioxide (CO₂); diffusing the H₂ in the product gas through the tubular membrane into a bore of the tubular membrane, where the tubular membrane is hydrogen selective; discharging the H₂ from the bore of the tubular membrane; discharging a remainder of the product gas from the region external to the tubular membrane; and generating heat using the H₂ as fuel, where the heat is used for the steam cracking.

In an aspect, combinable with any other aspect, the reforming is autothermal reforming, the method further including providing oxygen (O₂) into the reformer.

In an aspect, combinable with any other aspect, the method includes providing a steam into the reformer.

In an aspect, combinable with any other aspect, the method includes providing an additional hydrocarbon into the reformer.

In an aspect, combinable with any other aspect, the method includes maintaining a reaction temperature in the reaction vessel during the WGS between 450° C. and 500° C.

In an aspect, combinable with any other aspect, the method includes separating the CO₂ from the remainder of the product gas.

In an aspect, combinable with any other aspect, a heat required for the steam cracking is provided entirely from the H₂.

In an aspect, combinable with any other aspect, the steam cracking forms by-product H₂, and the method further includes separating the by-product H₂ prior to providing the tail gas into the reaction vessel to the region.

An implementation described herein provides a system of steam cracking including: a steam cracker to generate an olefin product and a tail gas including methane from a feed; a membrane reactor coupled to the steam cracker, the membrane reactor including, a reaction vessel to produce a product gas including hydrogen (H₂) from a feed gas from the steam cracker, and a tubular H₂-selective membrane in the reaction vessel to diffuse the H₂ through the tubular H₂-selective membrane into a bore of the tubular H₂-selective membrane; and a heater coupled to the steam cracker and the membrane reactor, the heater configured to, receive the H₂ from the bore, generate heat from the H₂, and provide the heat to the steam cracker.

In an aspect, combinable with any other aspect, the system of steam cracking further includes a reformer disposed between the steam cracker and the membrane reactor, where the reformer is configured to reform the tail gas to form a syngas, where the feed gas includes the syngas.

In an aspect, combinable with any other aspect, the reaction vessel is tubular, and the reaction vessel and the tubular H₂-selective membrane are positioned concentrically.

In an aspect, combinable with any other aspect, the reaction vessel includes an outlet to discharge a remainder of the product gas, and where the bore includes an outlet to discharge the H₂.

In an aspect, combinable with any other aspect, the reaction vessel includes a catalyst for producing the H₂.

While this invention has been described with reference to illustrative implementations, this description is not intended to be construed in a limiting sense. Various modifications and combinations of the illustrative implementations, as well as other implementations of the invention, will be apparent to persons skilled in the art upon reference to the description. It is therefore intended that the appended claims encompass any such modifications or implementations.

What is claimed is:

1. A method of processing, the method comprising:
performing steam cracking of a feed to generate an olefin product and a tail gas comprising methane;
reforming the methane to form a syngas comprising hydrogen (H₂) and carbon monoxide (CO);
providing the syngas into a reaction vessel to a region external to a tubular membrane in the reaction vessel;
providing a steam into the reaction vessel to the region;
performing water-gas shift reaction (WGS) of the syngas in the reaction vessel to form a product gas comprising the H₂ and carbon dioxide (CO₂);
diffusing the H₂ in the product gas through the tubular membrane into a bore of the tubular membrane, wherein the tubular membrane is hydrogen selective;
discharging the H₂ from the bore of the tubular membrane;
discharging a remainder of the product gas from the region external to the tubular membrane; and
generating heat using the H₂ as fuel, wherein the heat is used for the steam cracking.

2. The method of claim 1, wherein the reforming of the methane is performed in the reaction vessel, the method further comprising:
providing the tail gas into the reaction vessel to the region; and
performing steam methane reforming (SMR) of the tail gas in the reaction vessel to form the syngas.

3. The method of claim 2, further comprising providing an additional hydrocarbon into the reaction vessel to the region external to the tubular membrane.

4. The method of claim 2, further comprising maintaining a reaction temperature in the reaction vessel during the SMR between 550° C. and 600° C.

5. The method of claim 1, further comprising separating the CO₂ from the remainder of the product gas.

6. The method of claim 1, wherein a heat required for the steam cracking is provided entirely from the H₂.

7. The method of claim 1, wherein the steam cracking forms by-product H₂, the method further comprising separating the by-product H₂ prior to providing the tail gas into the reaction vessel to the region.

8. A method of processing, the method comprising:
performing a steam cracking of a feed to generate an olefin product and a tail gas comprising methane;
reforming the methane in a reformer to form a syngas comprising hydrogen (H₂) and carbon monoxide (CO);
providing the syngas and a steam into a reaction vessel to a region external to a tubular membrane in the reaction vessel;
performing a water-gas shift reaction (WGS) in the reaction vessel to form a product gas comprising the H₂ and carbon dioxide (CO₂);
diffusing the H₂ in the product gas through the tubular membrane into a bore of the tubular membrane, wherein the tubular membrane is hydrogen selective;
discharging the H₂ from the bore of the tubular membrane;
discharging a remainder of the product gas from the region external to the tubular membrane; and
generating heat using the H₂ as fuel, wherein the heat is used for the steam cracking.

9. The method of claim 8, wherein the reforming is autothermal reforming, the method further comprising providing oxygen (O₂) into the reformer.

10. The method of claim 8, further comprising providing a steam into the reformer.

11. The method of claim 8, further comprising providing an additional hydrocarbon into the reformer.

12. The method of claim 8, further comprising maintaining a reaction temperature in the reaction vessel during the WGS between 450° C. and 500° C.

13. The method of claim 8, further comprising separating the CO₂ from the remainder of the product gas.

14. The method of claim 8, wherein a heat required for the steam cracking is provided entirely from the H₂.

15. The method of claim 8, wherein the steam cracking forms by-product H₂, the method further comprising separating the by-product H₂ prior to providing the tail gas into the reaction vessel to the region.

16. A system of steam cracking comprising:
a steam cracker to generate an olefin product and a tail gas comprising methane from a feed;
a membrane reactor coupled to the steam cracker, the membrane reactor comprising,
a reaction vessel to produce a product gas comprising hydrogen (H₂) from a feed gas from the steam cracker, and
a tubular H₂-selective membrane in the reaction vessel to diffuse the H₂ through the tubular H₂-selective membrane into a bore of the tubular H₂-selective membrane; and
a heater coupled to the steam cracker and the membrane reactor, the heater configured to,
receive the H₂ from the bore,
generate heat from the H₂, and
provide the heat to the steam cracker.

17. The system of claim 16 further comprising a reformer disposed between the steam cracker and the membrane reactor, the reformer configured to reform the tail gas to form a syngas, wherein the feed gas comprises the syngas.

18. The system of claim 16, wherein the reaction vessel is tubular, and wherein the reaction vessel and the tubular H₂-selective membrane are positioned concentrically.

19. The system of claim 18, wherein the reaction vessel comprises an outlet to discharge a remainder of the product gas, and wherein the bore comprises an outlet to discharge the H₂.

20. The system of claim 16, wherein the reaction vessel comprises a catalyst for producing the H₂.
